(19) United States
(12) Patent Application Publication
(10) Pub. No.: US 2002/0042340 A1
(43) Pub. Date: Apr. 11, 2002

(54) Catalyst carrier carrying nickel ruthenium and lanthanum

(76) Inventors: John Kevin Dunleavy, Darlington (GB); Rodney Martin Sambrook, Chesterfield (GB)

Correspondence Address: PILLSBURY WINTHROP LLP, 1600 TYSONS BOULEVARD, MCLEAN, VA, 22102, US

(21) Appl. No.: 09/909,983

(22) Filed: Jul. 23, 2001

Related U.S. Application Data
(63) Continuation of application No. PCT/GB99/02376, filed on Jul. 21, 1999.

(30) Foreign Application Priority Data
Jan. 21, 1999 (GB) PCT/GB99/00207

(51) Int. Cl. B01J 23/10

(52) U.S. Cl. 502/303

(57) ABSTRACT

A catalyst, especially for steam reforming hydrocarbons, comprises nickel and ruthenium metals in intimate admixture with lanthana and alumina on a preformed, preferably porous, carrier.

The present invention relates to catalysts and in particular to catalysts for use-for the steam reforming of hydrocarbons such as methane, natural gas, LPG, and naphtha. In the steam reforming of hydrocarbons, a mixture of a hydrocarbon feedstock and steam is passed at an elevated temperature over a steam reforming catalyst. The catalyst is often disposed in externally heated tubes. The steam ratio, i.e. the number of moles of steam employed per gram atom of hydrocarbon carbon, is typically in the range 1 to 5. For economic reasons it is desirable to use low steam ratios. However when using low steam ratios, particularly where the hydrocarbon contains hydrocarbons having 2 or more carbon atoms, there is a risk that carbon will be deposited on the catalyst, resulting in a loss of activity of the catalyst.

It is known from EP 0 044 117 to employ as catalysts for the steam reforming of hydrocarbons certain compositions obtained by reducing a precursor comprising a preformed carrier, particularly a ceramic body, carrying an intimate mixture of nickel, aluminium and lanthanum compounds. In use, the active catalyst comprises nickel metal intimately associated with the other components in oxide form, i.e. alumina and lanthana. We have found that the incorporation of ruthenium into such compositions gives-catalysts that have improved resistance to carbon deposition and which may also have increased activity.

Accordingly the present invention provides a catalyst comprising a preformed carrier carrying nickel and ruthenium metals intimately associated with alumina and lanthana.

The active catalyst may be made by subjecting to reducing conditions, a precursor comprising a preformed carrier carrying an intimate mixture of oxides of nickel, aluminium and lanthanum, and ruthenium and/or ruthenium oxide, whereby the nickel oxide and any ruthenium oxide are reduced to the elemental metals. Generally in the precursors made by the methods described hereinafter the ruthenium will be present as ruthenium metal which in some cases may have a surface coating of ruthenium oxide.

The preformed carrier is preferably a porous ceramic body adapted to hold the catalyst in the pores thereof and optionally also on the exterior of the ceramic body. The preformed carrier may be a ceramic foam. The preformed carrier may be formed from alumina, stabilised alumina, calcium aluminate cement, zirconia, spinel, aluminosilicates, silica, and the like, and is preferably in the form of cylindrical pellets, which may have one or more holes extending axially therethrough, e.g. Raschig rings. The cylindrical pellets preferably have a diameter in the range 5 to 20 mm and an aspect ratio, i.e. the ratio of the height to the diameter, in the range 0.5:1 to 2:1.

Accordingly the present invention also provides a catalyst precursor comprising cylindrical pellets, which may have one or more holes extending axially therethrough, of a carrier material carrying an intimate mixture of oxides of nickel, aluminium and lanthanum, and ruthenium and/or ruthenium oxide.

The catalyst precursor preferably contains 5 to 30% by weight of nickel as nickel oxide, NiO, 0.1 to 15% by weight of lanthanum as lanthanum oxide La₂O₃, and 0.1 to 2.5% by weight of ruthenium as metal and/or ruthenium oxide, based on the total weight of the precursor. As indicated above, the carrier material of the support may be, or contain, alumina. In the catalysts and precursors of the invention, alumina is present in intimate admixture with the nickel (or nickel oxide), ruthenium (and/or ruthenium oxide), and lanthana in addition to any alumina in the carrier material. Preferably the precursor contains 0.5 to 10% by weight of aluminium, as alumina Al₂O₃, based on the total weight of the precursor, in intimate admixture with the nickel oxide, ruthenium oxide and lanthanum oxide, in addition to any alumina present in the carrier material.

Correspondingly the reduced catalysts preferably contain, based upon the total weight of the reduced catalyst, about 5 to about 33% by weight of nickel metal, about 0.1 to about 2.5% by weight of ruthenium metal, about 0.1 to about 20% by weight of lanthana and about 1 to 20% by weight of alumina (in addition to any alumina present in the carrier material).

The nickel to lanthanum atomic ratio is preferably in the range 4:1 to 12:1 and the nickel to aluminium (in addition to any aluminium present in the carrier material) atomic ratio is preferably in the range 1.5:1 to 6:1, particularly 1.5:1 to 4:1. The ruthenium to nickel atomic ratio is preferably in the range 0.002:1 to 0.15:1, particularly 0.01:1 to 0.1:1.

The precursor may be formed impregnation of a preformed carrier, e.g. porous ceramic body, especially cylindrical pellets as aforesaid, with a solution containing heat-decomposable nickel, aluminium and lanthanum salts, e.g. nitrates, followed by calcination to effect decomposition of said salts. To incorporate the ruthenium component, the carrier is impregnated with a solution of a decomposable ruthenium salt, e.g. ruthenium chloride, before, simultaneously with, or after impregnation with the nickel, aluminium and lanthanum salts. indeed, the ruthenium salt may be included in the solution containing the nickel, aluminium and lanthanum salts. Alternatively, a precursor comprising the preformed carrier carrying an intimate mixture of nickel, aluminium and lanthanum oxides, for example as obtained by calcination of a porous ceramic body impregnated with heat-decomposable nickel, aluminium and lanthanum salts, may be impregnated with a solution of a ruthenium salt and then calcined to decompose the ruthenium salt. The calcination step or steps are preferably effected by heating the impregnated carrier in air at a temperature in the range 250° C. to 600° C., particularly at about 450° C.

In another preferred method of forming the precursor, a porous carrier is impregnated with a solution containing nickel, aluminium and lanthanum salts and a hydrolysable precipitation agent such as urea, and then, after draining any excess of the solution from the carrier, heating the impregnated carrier to effect controlled hydrolysis of the precipitation agent so as to increase the pH of the absorbed solution to effect precipitation of heat-decomposable nickel, aluminium and lanthanum compounds, e.g. hydroxides, within the pores of the carrier. The precursor is then calcined to convert the precipitated nickel, aluminium and lanthanum compounds to the corresponding oxides. The ruthenium may be incorporated by impregnation of the carrier with a heat-decomposable ruthenium salt solution before impregnation with the nickel, aluminium and lanthanum salts. Alternatively a ruthenium salt may be included in the solution of nickel, aluminium and lanthanum salts and precipitation agent, so that ruthenium or a compound thereof is precipitated with the nickel, aluminium and lanthanum compounds. Alternatively, and preferably, a precursor comprising a preformed porous carrier carrying nickel, aluminium and lanthanum compounds precipitated as aforesaid may be impregnated with a solution of a heat-decomposable ruthenium salt before or, preferably after, the calcination step. Where a calcined precursor comprising the porous carrier carrying precipitated nickel, aluminium and lanthanum compounds is impregnated with a solution of a heat-decomposable ruthenium salt, the resultant product should be subjected to a further calcination step to decompose the ruthenium salt.

The metal loading of the catalyst may be increased by repetition of the process steps. Prior to re-impregnation of the carrier, it is preferably to re-open any pores therein for example by thermal decomposition of material within the pores, e.g. by calcination as aforesaid. Alternatively the impregnated carrier is washed with water or weak alkaline solution and then dried at a suitable elevated temperature prior to re-impregnation.

Promoters such as zirconium or magnesium oxides may be added to further increase the stability and/or improve the selectivity of the catalyst. Such promoters may be incorporated by including a suitable salt, e.g. nitrate, in the solution employed to introduce the nickel. If magnesium oxide is present in the intimate mixture, it is preferred that the nickel to magnesium atomic ratio is in the range 1:1 to 20:1.

The catalysts of the invention are primarily of utility for the steam reforming of hydrocarbons. As indicated above, in such a process, a mixture of the hydrocarbon feedstock and steam is passed over the reduced catalyst at an elevated temperature. Generally the process is operated such that the temperature of the reformed gas mixture leaving the catalyst has a temperature in the range 450° C. to 850° C. The catalysts are of particular utility for the so-called “high-temperature” steam reforming process wherein the catalyst is disposed tubes and a preheated mixture of the hydrocarbon feedstock and steam is passed through the tubes, which are typically several metres long, e.g. 3 to 15, particularly at least 10, m long, and have an inside diameter in the range 6 to 20 cm and which are externally heated so that the temperature of the reformed gas leaving the tubes is in the range from about 6000C. to about 850° C. Often the process is operated at an elevated pressure, for example in the range 10 to 50 bar abs. Prior to reforming, the hydrocarbon feedstock should be desulphurised since sulphur compounds tend to deactivate nickel-containing steam reforming catalysts. Since the tendency to form carbon deposits is most prevalent in the inlet portion of the reforming tubes, in a preferred steam reforming process, the catalyst or precursor of the invention is charged to the inlet portion of the tubes, for example the first 5 to 40% of the length of the tubes, and a ruthenium-free steam reforming catalyst, or a precursor thereto, e.g. nickel (optionally in intimate admixture with lanthana and alumina) on a suitable preformed carrier, is charged to the remainder of the length of the tubes.

The catalysts, particularly those containing a relatively high nickel content, e.g. above 20% by weight, are also of utility for the so-called “low-temperature” steam reforming process, otherwise termed “pre-reforming”, where a preheated mixture of steam and hydrocarbon feedstock is passed adiabatically through a bed of the catalyst. In such a process, the temperature of the reformed gas mixture leaving the catalyst is typically in the range 450° C. to 600° C.

Other possible applications of the catalysts include the methanation of gases containing high concentration of carbon oxide particularly arising from coal gasification processes.

In the aforementioned steam reforming and methanation processes, the vessel, e.g. tubes, in which the reaction is to take place, may be charged with the precursor which is then reduced in situ by passing hydrogen diluted with an inert gas such as nitrogen through the precursor at an elevated temperature.

The invention is illustrated by the following examples.

Example 1 (comparative)

A catalyst precursor A was prepared by co-precipitating an intimate mature of nickel, lanthanum and aluminium compounds from a solution containing nickel, lanthanum and aluminium nitrates and urea in the pores of an alpha-alumina carrier by the procedure of EP 0 044 118 B, and then calcining the product at 450° C.

Example 2

A catalyst precursor B was prepared by the procedure of Example 1 except that the alpha-alumina carrier was impregnated with a solution of ruthenium chloride, followed by calcination, prior to co-precipitating the intimate mixture of nickel, ruthenium, lanthanum and aluminium compounds.

Example 3

A catalyst precursor C was prepared by the procedure of Example 1 except that the solution containing nickel, lanthanum and aluminium nitrates and urea also contained ruthenium chloride.

Example 4

A catalyst precursor D was prepared by the procedure of Example 1 and then, after calcination, was impregnated with a solution of ruthenium chloride, followed by a further step of calcination at 450° C.

The precursors all contained about 10% by weight of nickel as nickel oxide, 2.5% by weight of lanthanum as lanthana, and about 1.5% by weight aluminium as alumina (in addition to the alpha-alumina present as the carrier). The precursors B, C and D each also contained about 0.2% by weight of ruthenium.

To test the catalytic activity, each precursor was charged to an externally heated tube and reduced to the active catalyst by passing a mixture of hydrogen and nitrogen containing about 2% by volume of hydrogen through the precursor at atmospheric pressure while heating to about 600° C. Liquid hexane was vaporised at a rate of 3.5 ml per hour per ml of catalyst precursor charged to the tube and mixed with such an amount of steam to give the desired steam to hydrocarbon carbon ratio then the resultant mixture was passed through the reduced catalyst at atmospheric pressure while heating the tube to give an exit temperature of 750° C. The test was repeated for various steam to hydrocarbon carbon ratios. The activity was assessed by comparing the extent of reforming to that given by a standard catalyst. The results are shown in the following table.

| | Relative activity at steam ratio | | |
|---|---|---|---|
| Catalyst precursor | 3:1 | 3.5:1 | 4:1 |
| A (comparative) | 102.8 | 105.2 | 105.6 |
| B | 102.6 | 105.1 | 106.1 |
| C | 103.2 | 105.4 | 106.8 |
| D | 106.7 | 108.3 | 108.3 |

At steam ratios of 3:1 and 3.5:1, the catalyst A exhibited traces of carbon. The tests on the ruthenium containing materials, catalysts B, C and D, were completely free of carbon deposits indicating a superior performance at lower steam to carbon ratios. The results also demonstrate that the catalysts containing ruthenium incorporated at the same time as, or particularly after, the nickel, aluminium and lanthanum compounds had better activity in steam reforming than the ruthenium-free catalyst A.

What is claimed is:

1. A steam reforming catalyst comprising a preformed carrier carrying nickel and ruthenium metals intimately associated with alumina and lanthana.

2. A steam reforming catalyst according to claim 1 containing about 6 to about 33% by weight of nickel metal, about 0.1 to about 2.5% by weight of ruthenium metal, about 0.1 to about 20% by weight of lanthana, and about 1 to 20% by weight of alumina (in addition to any alumina present as the carrier), said percentages being based upon the total weight of the catalyst.

3. A steam reforming catalyst according to claim 1 wherein the nickel to lanthanum atomic ratio is in the range 4:1 to 12:1 and the nickel to aluminum (in addition to any aluminum present in the carrier) atomic ratio is in the range 1.5:1 to 6:1.

4. A steam reforming catalyst according to claim 1 wherein the ruthenium to nickel atomic ratio is in the range 0.002:1 to 0.15:1.

5. A steam reforming catalyst precursor comprising cylindrical pellets of a carrier carrying an intimate mixture of oxides of nickel, aluminum and lanthanum, and at least one ruthenium species selected from the group consisting of ruthenium metal and ruthenium oxide.

6. A steam reforming catalyst precursor according to claim 5 wherein the cylindrical pellets have at least one hole extending axially therethrough.

7. A steam reforming catalyst precursor according to claim 5 wherein the cylindrical pellets have a diameter in the range 5 to 20 mm and an aspect ratio in the range 0.5:1 to 2:1.

8. A steam reforming catalyst precursor according to claim 5 containing 5 to 30% by weight of nickel as nickel oxide, NiO, 0.1 to 15% by weight of lanthanum as lanthanum oxide, La₂O₃, and 0.1 to 2.5% by weight of ruthenium as at least one ruthenium species selected from the group consisting of ruthenium metal and ruthenium oxide, said weights being based on the total weight of the precursor.

9. A steam reforming catalyst precursor according to claim 8 containing 0.5 to 10% by weight of aluminum, as alumina Al₂O₃ based on the total weight of the precursor, in intimate admixture with the nickel oxide, lanthanum oxide and the ruthenium species, in addition to any alumina present in the carrier.
